(19) United States
(12) Patent Application Publication
(10) Pub. No.: US 2018/0337929 A1
(43) Pub. Date: Nov. 22, 2018

(54) Access Control in a Hybrid Cloud Infrastructure - Cloud Technology

(71) Applicant: Bank of America Corporation, Charlotte, NC (US)

(72) Inventor: Manu J. Kurian, Dallas, TX (US)

(21) Appl. No.: 15/597,601

(22) Filed: May 17, 2017

(51) Int. Cl. H04L 29/06; G06F 21/62

(52) U.S. Cl. CPC H04L 63/104; G06F 2221/2137; G06F 21/6209; H04L 63/108

(57) ABSTRACT

Access control in a hybrid cloud infrastructure may include receiving privacy settings with privacy groups and constituent privacy subcategories, registering the privacy groups and privacy subcategories according to the privacy settings, receiving a request to share files over the network, determining a privacy subcategory to associate with the files based on characteristics of the files, and assigning the privacy subcategory to the files. In particular embodiments, the system may receive subsequent access requests for any of the files and implement access control by granting or denying access to the file based on the assigned privacy groups or privacy subcategories.

### TECHNICAL FIELD

The present disclosure relates to access control in a cloud infrastructure, and more particularly to access control in a hybrid cloud infrastructure.

### BACKGROUND

Cloud systems can be used to store personal and commercial information. The information that is stored on the cloud may require different levels of confidentiality or sensitivity associated with them that are dictated by particular network users, or rules and regulations related to privacy. Existing cloud systems, however, do not provide segmented access to data stored on the cloud. Although existing cloud systems may provide access to individual users, they do not provide segmented data access to the same information to other network users through the same cloud. To facilitate a hybrid cloud infrastructure, systems and methods may be provided to permit access control and privacy management to data available in a cloud environment.

### SUMMARY OF THE DISCLOSURE

In accordance with the present disclosure, a system for access control and privacy management in a hybrid cloud infrastructure is provided is provided which substantially eliminates or reduces disadvantages and problems associated with previous systems and methods. According to a particular embodiment, implementing access control and privacy management in a hybrid cloud infrastructure may include receiving privacy settings including privacy groups and constituent privacy subcategories, registering the privacy groups and privacy subcategories according to the privacy settings, receiving a request to share a file over the network, determining a privacy subcategory to associate with the file, and assigning the privacy subcategory to the file. In particular embodiments, the system may receive subsequent requests for the file and grant or restrict access to the file based on the assigned privacy subcategory. In certain embodiments, privacy groups or privacy subcategories may be populated with members who may be granted access to files assigned to the privacy group or privacy subcategory. In particular implementations, members for a specific privacy group or privacy subcategory may be populated by the network user of a file associated with the privacy group or privacy subcategory. In other implementations, members for a specific privacy group or privacy subcategory may be populated automatically based on the detected relationship between the relevant network users. Certain embodiments support the association of timers or expiration dates with files in the cloud, privacy groups, and/or privacy subcategories, such that access is granted only before expiration of the timer or expiration date and restricted or denied thereafter.

Particular embodiments provide various technical advantages that overcome specific technical problems inherent to cloud computing and internet technology. In particular, the present disclosure provides a flexible framework that overcomes the conventional restrictions inherent to preexisting cloud environments. Specifically, conventional cloud computing systems are inherently rigid in their inability to provide dynamic access control by analyzing relationships between network users and characteristics of data and files stored in the cloud. In addition, conventional cloud infrastructures could not segment data in the cloud in a manner that provided a differentiated user access for network users and instead merely provided a network user access to their own data. As a result, those conventional systems had limited ability, if any, to share data located in the cloud between network users. Embodiments of the present disclosure specifically overcome these problems inherent to inflexible cloud environments that may contribute to limited sharing capabilities because they provide flexible access control and privacy management in a hybrid cloud infrastructure that overrides routine functionality of conventional cloud services and traditional access regimes. In addition, certain embodiments of the present disclosure implement dynamic population of members for privacy groups based on relationships between network users and dynamic assignment of files to corresponding privacy groups and privacy subcategories, such that access control is seamless and requires significantly less administrative or support control than conventional systems. As a result, techniques of the present disclosure provide specific solutions rooted in technology to overcome a problem arising in the realm of cloud environments.

The unconventional and non-generic arrangement of components of embodiments of the present disclosure provide a technological solution to overcome the shortcomings of conventional cloud environments. Embodiments of the present disclosure may permit cloud environments to provide dynamic access control and privacy management based on network user relationships and file characteristics. The dynamic nature of the access control and privacy management techniques enables the cloud environment to require significantly less administrative control and provides shared access to the same information in a segmented manner. This results in efficient use of cloud resources and minimizes the existence of duplicative or cumulative information in the cloud for different network users that instead can share segmented access to the same information. Embodiments of the present disclosure also provide version control in the cloud that minimizes or eliminates the storage of stale or expired information on the cloud, thereby efficiently using cloud resources. Thus, techniques of the present disclosure provide a technological solution that overrides the operation of conventional inflexible cloud environments that were not suited for dynamic access control and privacy management.

Thus, a flexible framework is disclosed that that may be configured, built and deployed in a network environment to enable access control and privacy management in a hybrid cloud infrastructure.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present disclosure and its features and advantages, reference is now made to the following description, taken in conjunction with the accompanying drawings, in which:

FIG. 1 is a block diagram illustrating a system environment with elements that interoperate to provide a hybrid cloud infrastructure.

FIG. 2 is a block diagram illustrating an example cloud privacy management server for performing various aspects of providing a hybrid cloud infrastructure;

FIG. 3 illustrates example privacy groups that may be used in a hybrid cloud infrastructure; and

FIG. 4 illustrates an example process flow for providing a hybrid cloud infrastructure.

### DETAILED DESCRIPTION

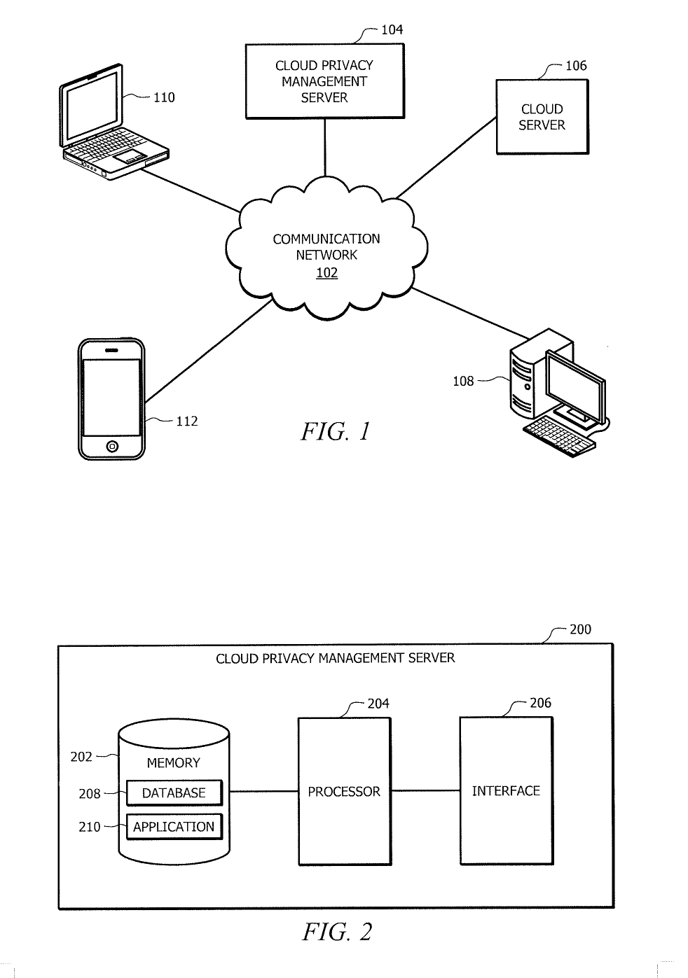

Embodiments of the present disclosure and its advantages are best understood by referring to FIGS. 1-4, like numerals being used for like and corresponding parts of the various drawings.

FIG. 1 is a block diagram illustrating a system 100 with elements that interoperate to provide access control and privacy management in a hybrid cloud infrastructure. The elements of system 100 can support a number of different operations, including receiving privacy settings, registering a privacy group according to the privacy settings, receiving a request to share a file over the network, determining a privacy subcategory to associate with the file, and assigning the privacy subcategory to the file. In particular embodiments of system 100, the system may grant subsequent access to the file based on the assigned privacy groups or privacy subcategory.

The privacy settings may include one or more privacy groups and at least one privacy subcategory for each privacy group. In certain embodiments, privacy groups or privacy subcategories may be populated with members who may be granted access to files assigned to the privacy group or privacy subcategory. In particular implementations, members for a specific privacy group or privacy subcategory may be populated by the owner of a file associated with the privacy group or privacy subcategory. For example, a user that uploads a file that is associated with a particular privacy subcategory may identify other users that should be a member of the privacy subcategory, such that they have access to the file. In other implementations, members for a specific privacy group or privacy subcategory may be populated automatically based on detected relationships between users. For example, the system may determine after a user uploads a photograph that is associated with a particular privacy group or subcategory, that other users depicted in the same photograph should be populated as members of the same privacy group or subcategory, such that they may have access to the same photograph. As another example, metadata associated with a shared file may influence whether network users become members of a privacy subcategory or privacy group. Some embodiments may also permit timers or expiration dates to be associated with files in the cloud, privacy groups, and/or privacy subcategories, such that access is granted only before expiration.

In the illustrated embodiment, system 100 includes a number of elements interconnected by one or more networks, represented by communications network 102. Communications network 102 represents communications equipment, including hardware and any appropriate controlling logic, for interconnecting elements and facilitating communication between these elements. Communications network 102 may include local area networks (LANs), metropolitan area networks (MANs), wide area networks (WANs), any other public or private network, local, regional, or global communication network such as the Internet, enterprise intranet, other suitable wired or wireless communication link, or any combination thereof. Communications network 102 may include any combination of gateways, routers, hubs, switches, access points, base stations, and any other hardware, software, or a combination of the preceding that may implement any suitable protocol. Communications network 102 may include other types of networks, including wireless or wired networks. The use of communications network 102 facilitates seamless access to and management of a hybrid cloud infrastructure regardless of the geographic location or communication protocols employed by network components or devices on the network. While only one communications network 102 has been illustrated, it should be understood that various embodiments may operate using multiple communications networks 102. In addition, various embodiments may employ one or more wired and wireless networks in communications networks 102.

Communications network 102 interconnect other elements of system 100, including cloud privacy management server 104, cloud server 106, desktop computer 108, laptop computer 110, and mobile device 112. It should be understood that while system 100 is illustrated as including a single communications network connected to specific components, various embodiments may operate using any suitable arrangement and collection of networks and components that enable appropriate communications.

The illustrated embodiment of system 100 also includes a cloud privacy management server 104 coupled to communications network 102. Cloud privacy management server 104 represents any appropriate combination of hardware, controlling logic, and data for managing and providing a hybrid cloud infrastructure that facilitates segmentation of data. For example, cloud privacy management server 104 may represent a networked server or collection of networked servers capable of communicating with other elements of system 100 to communicate with cloud server 106, to dynamically manage privacy and access to data in hybrid cloud environment across communications network 102. In particular embodiments, cloud privacy management server 104 may be accessed by various devices including, for example, by desktop computer 108, laptop computer 110, and mobile device 112, to share and access files managed by the cloud privacy management server 104 and/or cloud server 106. As illustrated, cloud privacy management server 104 couples to communications network 102 to facilitate communication with other elements of system 100. For example, cloud privacy management server 104 may communicate with and manage privacy and access to data and information accessible on cloud server 106. In particular embodiments, cloud privacy management server 104 may operate as a web server or web portal accessible across the communications network 102 by various devices, including desktop computer 108, laptop computer 110, and mobile devices 112.

According to particular implementations, cloud privacy management server 104 can provide users with an appropriate interface to provide access controls to be applied to files accessible on a cloud server. For example, a family photograph may be made accessible to those family members depicted in the photograph. As another example, if a user uploads a copy of their driver's license to the cloud, the department of motor vehicles that issued the driver's license may be provided access to license for various purposes, such as for renewal of the driver's license. In particular embodiments, characteristics of the file, such as its metadata or its contents, may facilitate associating the file with particular privacy groups, such that access controls are implemented according to those privacy group settings. Metadata may represent any data or properties that describe or otherwise provide information about a file or other data. In some embodiments, the metadata may include author, co-author, collaborator, or affiliated entity associated with the data or file. Certain embodiments permit populating the users or members that constitute a particular privacy group or privacy subcategory. In some implementations, members are populated by users granting access to files associated with a particular privacy group or privacy subcategory. In other implementations, members are populated by detecting relationships between users or users associated with particular files, groups, or categories. Particular embodiments may permit associating files with a timer or expiration date and granting access to files on a cloud based on whether the timer or date has expired. For example, a user may be granted access to a file before a timer or date associated with the file expires. In other implementations, different privacy groups or privacy subcategories may have different timers or dates associated with the same file or group of files. For example, different privacy groups or privacy subcategories may be granted access to the same file or collection of files for varying periods of time.

Cloud privacy management server 104 may include memory, processors, databases, and appropriate interfaces to couple to other devices or networks. Particular implementation of cloud privacy management server 104 may include the use of one or more data servers or mesh computing environments. In certain implementations, cloud privacy management server 104 may provide a flexible hybrid cloud infrastructure that dynamically manages access control and privacy. In particular embodiments, cloud privacy management server 104 may include a relational database for storing relevant information associated with the flexible access control in a hybrid cloud environment, including maintaining file characteristics such as metadata, some of all contents of the files stored on the cloud, analysis based on the contents of files stored on the cloud, timers or dates associated with the files stored on the cloud, or other appropriate properties and parameters associated with access control and privacy management. While system 100 depicts a single cloud privacy management server 104, it should be understood that various embodiments may operate using any number of cloud privacy management servers. In addition, various embodiments may incorporate the functionality and/or hardware of cloud privacy management server 104 in other servers (e.g., cloud server 106), computers, or networks. In particular embodiments, cloud privacy management server 104 would be located on an enterprise or protected network. In certain embodiments, access to cloud privacy management server 104 may be limited to a private network while in other embodiments cloud privacy management server 104 may be accessed from a public communication network, such as the Internet.

As illustrated, system 100 includes a cloud server 106 coupled to communications network 102. Cloud server 106 represents any appropriate combination of hardware, controlling logic, and data for managing files and data in an network accessible environment. Cloud server 106 may include memory, processors, databases, and appropriate interfaces to couple to other devices or networks. Particular implementation of cloud server 106 may include the use of one or more data servers or mesh computing environments. For example, cloud server 106 may represent a networked server or collection of networked servers capable of communicating with other elements of system 100 to provide cloud services and resources.

Cloud server 106 may include processors such as central processing units (CPUs) or other suitable processing unit, random access memory (RAM), read only memory (ROM), solid state storage devices, magnetic storage devices, optical storage devices, or any other suitable information storage device or a combination of such devices. Cloud server 106 may include any suitable combination of volatile or non-volatile, local or remote devices suitable for storing and maintaining information. In particular embodiments, cloud server 106 may include a relational database for storing relevant information associated with flexible access control.

Access to information, data, or files at cloud server 106 may be managed by other elements of system 100, such as cloud privacy management server 104. In certain implementations, cloud server 106 may facilitate processing or storage of appropriate information, data, or files. For example, while cloud server 106 may operate as a central repository for data, access control and privacy management of those files may be handled by, or in collaboration with, cloud privacy management server 104. In certain embodiments, cloud server 106 may represent one or more proprietary or enterprise data servers. In other embodiments, cloud server 106 may represent one or more third party data servers that operate as a fixed or on-demand cloud service. In those embodiments, the hardware and functionality of cloud server 106 may be provided by third party data servers.

In particular embodiments, cloud server 106 communicates with various devices including, for example, by cloud privacy management server 104, desktop computer 108, laptop computer 110, and mobile device 112, to perform the operations of the present disclosure. As illustrated, cloud server 106 couples to communications network 102 to facilitate communication with other elements of system 100. For example, cloud server 106 may communicate with and be managed by cloud privacy management server 104 to provide access control and privacy management in a hybrid cloud infrastructure according to embodiments of the present disclosure. In some embodiments, the functionality and resources of cloud server 106 may reside on or be directly coupled to cloud privacy management servers, such as cloud privacy management server 104.

While system 100 depicts a single cloud server 106, it should be understood that various embodiments may operate using any number of cloud servers. In addition, various embodiments may incorporate the functionality and/or hardware of cloud server 106 in other servers, computers, or networks. In particular embodiments, the functionality and hardware of cloud server 106 may be incorporated into, or co-located with, cloud privacy management server 104. In certain embodiments, access to cloud server 106 may be limited to a private network while in other embodiments cloud server 106 may be accessed from a public communication network, such as the Internet.

The illustrated embodiment of system 100 also includes endpoint devices including desktop computer 108, laptop computer 110, and mobile device 112 coupled to communications network 102. These devices represent any suitable hardware, including appropriate controlling logic and data, capable of connecting to and communicating over a network. For example, desktop computer 108 may represent a workstation used at an enterprise or a desktop personal computer. Laptop computer 110 may represent any personal or business notebook computer. Mobile device 112 may represent advanced phones (e.g, smartphone), Voice over Internet Protocol (VoIP) telephones, mobile phones, tablet, personal digital or data assistants, or other appropriate portable computing device. Endpoint devices coupled to communications network 102 may include wired or wireless devices. Other suitable endpoint devices include, but are not limited to, workstations, laptops or notebook computer systems, printers, Voice over Internet Protocol (VoIP) telephones, IP phones, mobile telephones, advanced phones (e.g., smartphones), personal digital assistants (PDAs), wireless handsets, notebook computer systems, tablet computer systems, embedded devices, auxiliary devices, or the like. In particular embodiments, endpoint devices 106 are capable of transmitting and receiving different forms of media including audio, video, images, text messages, and other data formats, and documents and accessing disparate network-based services. While system 100 depicts particular embodiments of endpoint devices as desktop computer 108, laptop computer 110, and mobile device 112, it should be understood that suitable embodiments may include any device that can be used to communicate across communications network 102, such as with cloud privacy management server 104 and/or cloud server 106.

Particular embodiments are designed to operate in a network environment that provides a flexible access control and privacy management using a hybrid cloud infrastructure. In particular embodiments, this process may include receiving privacy settings, registering the privacy group according to privacy settings, receiving a request to share the file over the network from a first user, determining the privacy subcategory of the registered privacy group to associate with the file based on a characteristic of the file, assigning the associated privacy group and/or subcategory to the file, and granting subsequent access the file based on the assigned privacy group and/or subcategory. The privacy settings may include one or more privacy groups and one or more privacy subcategories for the privacy group. In certain implementations, the process may include configuring appropriate privacy groups and privacy subcategories that define relationships and access to different types of data. For example, a privacy group dedicated to family access may include privacy subcategories for immediate and extended family. In that example, there may be particular information or files that only immediate family has access to and is not available to extended family members. Certain embodiments may permit populating privacy groups and privacy subcategories with members in different ways. For example, user members of a privacy group or a privacy subcategory may be configured by a network user or system administrator. In other embodiments, the user members of a privacy group or privacy subcategory may be automatically populated based on a relationship between users, or a relationship between a user and the information or privacy group or subcategory. Systems, methods, and software described by example in the present disclosure may increase the efficiency, speed, and effectiveness of access control across a network.

In operation, elements of system 100 operate together to perform various access control functions including but not limited to maintaining a repository of access control information on the network including information related to privacy groups and privacy subcategories, file characteristics such as metadata, file contents, or file content analysis, registering privacy groups and privacy subcategories, timers or expiration rules for particular information or files, and rules for maintaining access control and privacy that permit dynamic segmentation of information stored on the cloud. For example, in particular embodiments, elements of system 100 may allow a network user to effectively and seamlessly manage access control to information on the cloud. In certain embodiments, the interface provided by cloud privacy management server 104 would be a web portal or application interface that may be accessible by a network user on desktop computer 108, laptop computer 110, and/or mobile device 112. In some implementations, a network user may request sharing of a file and the system may intelligently determine which privacy group or privacy subcategory to associate with the file. In certain implementations, the network user may provide settings associated with configuring or registering a privacy group or privacy subcategory. For example, a network user of cloud services may cause desktop computer 108 to specify privacy settings that provide for a particular privacy group for family members and privacy subcategories for immediate and extended family. The same user may identify a file stored on cloud server 106 or upload a new file for storage on cloud server 106, and the system may determine based on the characteristics of the file whether to make the file available to the entire family privacy group, the immediate family privacy subcategory, and/or the extended family privacy subcategory. For example, if the file is a family photograph that includes only the immediate family members in the photograph, the system may make the file available only to those network users in the immediate family privacy subcategory.

In particular embodiments, one or more endpoint devices, such as desktop computer 108, laptop computer 110, and mobile device 112, connect or seek access to cloud privacy management server 104 to request access to information, data or files provided by cloud server 106 over communications network 102 for various purposes. For example, one of endpoint devices may request access to cloud privacy management server 104 across communications network 102 through desktop computer 108. In doing so, certain embodiments may provide a user interface, such a web portal or application interface, to allow a network user to provide privacy settings associated with privacy groups and privacy subcategories for registration, provide members to populate particular privacy groups or privacy subcategories with, or provide a file to be uploaded to cloud server 106 for sharing, or identify an existing file on cloud server 106 for sharing. In some embodiments, cloud privacy management server 104 will provide an appropriate user interface for any endpoint device, such as desktop computer 108, laptop computer 110, and mobile device 112, to provide parameters associated with the privacy groups and subcategories, members associated with specific privacy groups and subcategories, and particular files and file characteristics. In certain implementations, file characteristics influence the particular privacy group or privacy subcategory with which the file is associated. A file characteristic may include metadata or other properties of a file, the contents of the file, or some analytical deviation or combination thereof. Although particular file characteristics are enumerated, any appropriate and suitable characteristic or analysis of a file may be used by the system. In appropriate embodiments, a file to be shared may be assigned to a privacy group or privacy subcategory based on the analysis of the characteristic of the file. In appropriate embodiments, after the file is assigned with a particular privacy group or privacy subcategory, the system may subsequently receive request for access to the file by various network users.

According to particular implementations, the system may subsequently grant or deny access to specific network users to files stored in cloud server 106 based the registered privacy groups and subcategories and based on whether the particular network user has been defined as a member of the privacy group or subcategory associated with the requested file. According to particular embodiments, cloud privacy management server 104 may communicate with cloud server 106 to access and provide files stored on cloud server 106 to particular network users based on the registered privacy group or privacy subcategory. Some embodiments of cloud privacy management server 104 may further distinguish and control the level of access particular network users have with respect to files stored on cloud server 106. For example, levels of access may include access to read, write, or read and write.

Components of system 100 may include an interface, logic, memory, and/or other suitable element. An interface receives input, sends output, processes the input and/or output and/or performs other suitable operations. An interface may comprise hardware and/or software. Logic performs the operation of the component, for example, logic executes instructions to generate output from input. Logic may include hardware, software, and/or other logic. Logic may be encoded in one or more non-transitory tangible media, such as a computer-readable medium or any other suitable tangible medium, and may perform operations when executed by a computer. Certain logic, such as a processor, may manage the operation of a component. Examples of a processor include one or more computers, one or more microprocessors, one or more applications, and/or other logic. Any suitable logic may perform the functions of system 100 and the components within system 100.

While system 100 is illustrated as including specific components arranged in a particular configuration, it should be understood that various embodiments may operate using any suitable arrangement and collection of components capable of providing functionality such as that described. For example, although system 100 is illustrated as including desktop computer 108, laptop computer 110, and mobile device 112, any device capable of providing an interface to the user may be coupled to network 102 and employed within the context of this disclosure. Thus, any suitable portable or fixed device employed in accordance with the teachings of the present disclosure. In addition, although cloud privacy management server 104 and cloud server 106 are depicted as separate components, embodiments of the present disclosure may include systems where the functionality of both servers is provided by a single component or a distributed set of components.

FIG. 2 illustrates a system 200 as a particular embodiment of cloud privacy management server that is capable of providing access control in a hybrid cloud infrastructure according to particular control logic. In a particular embodiment, system 200 represents a proprietary cloud privacy management server that manages access control and privacy to provide a flexible hybrid infrastructure to network users.

As illustrated, system 200 may include various interconnected elements including a memory 202, a processor 204, and an interface 206. Memory 202 stores, either permanently or temporarily, data, operational software, or other information for processor 204.

Memory 202 represents any suitable combination of volatile or non-volatile, local or remote devices suitable for storing information. For example, memory 202 may include RAM, ROM, solid state storage devices, magnetic storage devices, optical storage devices, or any other suitable information storage device or a combination of such devices. As illustrated, memory 202 includes a database 208, and application 210 to facilitate access control and privacy management in a hybrid cloud infrastructure. Database 208 represents a relational database for storing and organizing various types of network information such as endpoint information, privacy settings, privacy group and privacy subcategories, member information for particular privacy groups and privacy subcategories, information related to file characteristics, rules and appropriate policies related to access control, timers and expiration dates related to files, historical or other statistical data related to access control, and any other appropriate information related to access control in a hybrid cloud infrastructure. In particular embodiments, database 208 may be any suitable database capable of organizing information.

Application 210 generally refers to logic, rules, algorithms, code, tables and/or other suitable instructions for performing the described functions and operations of system 200. In certain embodiments, application 210 may facilitate the interaction of system 200 with cloud server 106, desktop computer 108, laptop computer 110, and mobile device 112, using communications network 102.

Processor 204 represents one or more processing elements, including hardware, logic, and data capable of controlling the operation of system 200. For example, processor 204 may be a computer processor capable of executing a cloud access control and privacy management application stored in memory 202, or any other software or controlling logic associated with system 200, such as an appropriate operating system. According to particular embodiments, processor 204 may be a programmable logic device, a microcontroller, a microprocessor, any other appropriate processing device, or any suitable combination of the preceding.

Interface 206 represents any appropriate combination of hardware and controlling logic for coupling to one or more networks. Interface 206 may support any number of suitable protocols for communicating on a communication network. For example, network interface 206 may be a wired or wireless local area network interface, cellular network interface, satellite interface, and/or any other appropriate interface for communicating on a communication network. Interface 206 may have multiple interfaces for handling different communication protocols.

In operation, processor 204 may interact with interface 206 to receive privacy settings for controlling access by different network users, such as settings related to privacy groups or privacy subcategories. For example, privacy settings may specify the privacy group and privacy subcategories that may be associated with particular files and specific network users to control access to information. System 200 may register privacy groups and privacy subcategories and populate the privacy groups and/or privacy subcategories with specific members (e.g., other network users). In particular embodiments, processor 204 may interact with interface 206 to receive membership information pertaining to particular privacy groups and/or privacy subcategories. For example, a network user may identify specific family members that may populate the immediate family subcategory, and different family members that may populate the extended family subcategory. Similarly, a network user may populate other privacy groups and subcategories related to friends, work, financial, government, or other appropriate designations. In other embodiments, processor 204 may interact with interface 206 to access other networks, such as social media networks or databases, to determine a relationship between two network users such that the privacy group and privacy subcategories are populated with members corresponding to that relationship. For example, system 200 may detect a network user is the familial sibling of another network user, and as a result, populate the immediate family privacy subcategory of each network user with the other network user. In this manner, relationships associated with family, work, citizenship, residency, and other groups may be detected based on accessible information. Certain entities, such as employers, government, and financial institutions, may have their own databases that establish a relationship with particular network users such that coworkers, citizens, residents, and customer relationships can be identified to facilitate automatic population of privacy groups and privacy subcategories with members. Processor 204 may store privacy groups and subcategories and specific member information in database 208.

Processor 204 may interact with interface 206 to receive a request to share a file through communications network 102, for the purposes of providing access to the file to one or more network users. Processor 204 may execute appropriate control logic as defined by application 210 to determine and analyze characteristics associated with the file. Characteristics associated with the file may include metadata, contents of the file, or some combination or analysis thereof. Processor 204 may consult database 208 to determine the appropriate privacy group or privacy subcategory to associate with a file based on the determined characteristics of the file. For example, a family photograph with only immediate family members may be associated with the family privacy group and the immediately family subcategory. In this manner, system 200 may determine and classify information stored in a cloud and provide segmented access to that information to different cloud users based on particular privacy and access configurations.

Processor 204 may interact with interface 206 to receive a request for access to a file through communications network 102. As appropriate, processor 203 may consult database 208 to confirm that the requesting network user may be granted access to the file stored on the cloud server, such as cloud server 106. In some embodiments, files may have a timer or expiration date associated with them such that access to those files may only be granted prior to expiration of the timer or before the expiration date. For example, a driver's license may only be accessible to network users while it has not expired with the department of motor vehicles. In this manner, network users may be protected against accessing stale or old information. In particular embodiments, determining whether a network user should be granted access to a file may include determining whether the network user is a member of a privacy group or privacy subcategory associated with the requested file. Processor 204 may also maintain historical information about access history to particular files in database 208. Accordingly, particular embodiments include appropriate control logic as defined by application 210 that may be executed to dynamically grant segmented access to information in a hybrid cloud infrastructure.

In some embodiments, system 200 may communicate with other systems such as cloud server 106 or other servers or databases to provide access control and privacy management. Certain embodiments of system 200 are capable of receiving changes to privacy groups, privacy subcategories, members associated with particular privacy groups and privacy subcategories, and updates to particular files stored in the cloud server. Processor 204 can execute appropriate logic in application 210 to update database 208 and dynamically adjust the access control regime to account for such changes. In certain implementations, system 200, through interface 206 and the execution of application 210 by processor 204, is capable of periodically connecting to other networks (e.g., social media or other private or public networks) and databases (e.g., employer, government, or financial) to detect changes in relationships that may cause updates to the membership of privacy groups or subcategories. In this manner, system 200 may provide dynamic access control that reflects real world relationships between network users.

Thus, system 200 represents an example cloud privacy management server that is operable perform the functions of the present disclosure. While system 200 is illustrated as including specific components, it should be understood that various embodiments may operate using any suitable arrangement and collection of components. For example, the hardware and/or functionality of system 200 could be incorporated within a cloud server 106, or vice versa.

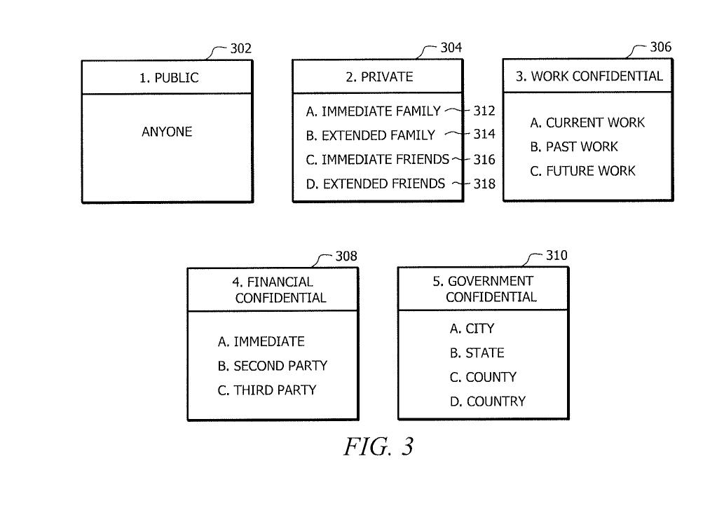

FIG. 3 illustrates example privacy groups that may be used in a hybrid cloud infrastructure. In a particular embodiment, tables 300 represent a set of privacy groups and constituent privacy subgroups that may be used by a proprietary cloud privacy management server to manage access control and privacy and provide a flexible hybrid infrastructure to network users. In particular embodiments, tables 300 or a representation thereof may be stored in database 208 and employed by a cloud privacy management server such as system 200 for a particular network user. As illustrated, tables 300 include five privacy groups, namely, public privacy group 302, private privacy group 304, work confidential privacy group 306, financial confidential privacy group 308, and government confidential privacy group 310.

As shown, each of the privacy groups contains at least one privacy subcategory that relates to the privacy group in some manner and provides a differentiated level of access. For example, private privacy group 304 includes four privacy subcategories that include immediate family privacy subcategory 312, extended family privacy subcategory 314, immediate friends privacy subcategory 316, and extended friends privacy subcategory 318. In particular implementations, information or files on the cloud server may be associated with one or more of these privacy subcategories. For example, a family photo of immediate family members may be associated with immediate family privacy subcategory 312. In addition, immediate family privacy subcategory may be populated with specific members that may form the immediate family of a particular network user. In certain implementations, access to files associated with immediate family privacy subcategory 312 may be granted, upon request, to network users who are members of the immediate family privacy subcategory. In a similar manner, members and cloud files may be associated with extended family privacy subcategory 314, immediate friends privacy subcategory 316, and extended friends privacy subcategory 318. In the illustrated embodiment of tables 300, privacy groups 302, 306, 308, and 310 also contain privacy subcategories that relate to each privacy group. In particular embodiments, information residing in the cloud (e.g., files) and members (e.g., network users) may be associated with the privacy subcategories included in each of those privacy groups. The relationships between the information, privacy groups/subcategories, and members may determine the level of access provided to particular network users. In some embodiments, a file or collection of files may be associated with more than one privacy group or privacy subcategory. In similar or other embodiments, a timer or expiration date may be associated with either a file or a privacy group or privacy subcategory to restrict access to a the file during a particular period of time or restrict access to members of a particular privacy group or privacy subcategory for a particular period of time, respectively. Such restrictions may be implemented independently (i.e., based on file-based or privacy group/subcategory) or in combination.

Thus, tables 300 represent an example configuration of privacy groups and privacy subcategories that may be employed by systems and methods of the present disclosure. While tables 300 illustrate particular privacy groups and privacy subcategories therein, it should be understood that various embodiments may operate using any suitable arrangement and collection of privacy groups and privacy subcategories. For example, another embodiment of tables 300 may include two privacy groups instead of private privacy category 304, where one is dedicated to family and the other is dedicated to friends. In that example, the family privacy group may include an immediate family privacy subcategory and an extended privacy family privacy subcategory. Similarly, the friends privacy group may include an immediate friends privacy subcategory and an extended friends privacy subcategory. Thus, tables 300 is merely an example configuration. The present disclosure contemplates any suitable and appropriate arrangement of privacy groups and privacy subcategories.

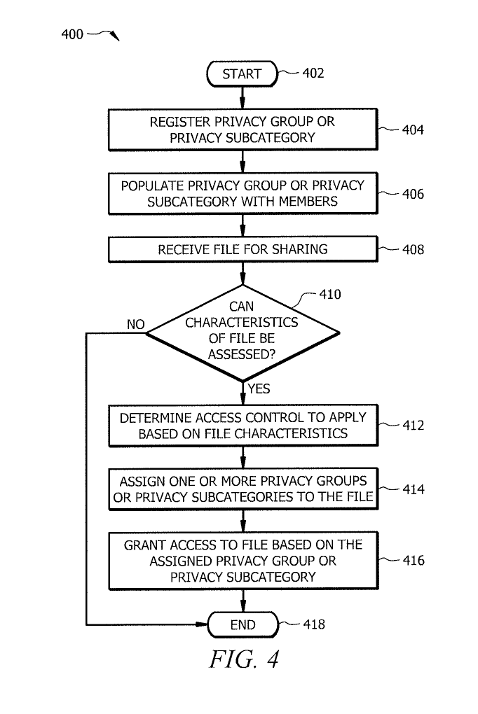

FIG. 4 is a process flow diagram illustrating process flow 400 for providing access control and privacy in a hybrid cloud infrastructure. The steps of process flow 400 correspond to an example sequence of steps for managing access control and privacy in a cloud environment. A process like process flow 400 may be implemented on an appropriate system, such as a cloud privacy management server.

In the illustration, process flow 400 includes a number of steps for registering privacy groups and privacy subcategories, and populating privacy groups and privacy subcategories with members. Process flow 400 also includes steps for receiving a file for sharing using a cloud, determining whether the characteristics of the file can be assessed, determine level of access to apply to the file based on file characteristics, assign privacy group or privacy subcategory to the file, and grant access to the file based on the assigned privacy group. In certain embodiments, appropriate policies may dictate whether, when, and how access control and privacy management may occur. For example, certain network policies may dictate whether a network user is permitted to change access control configurations associated with particular files. For example, other network policies may dictate whether a network user is permitted to change members (e.g., network users) associated with a privacy group or privacy subcategory. Certain rules may govern how long a file may be accessed from the cloud, for example, by using a timer or expiration date associated with the file. As shown, the process flow starts at step 402, and includes a registration step 404, a member population step 406, a receive file step 408, file characteristic decision step 410, a determine access control level step 412, a privacy assignment step 414, a file access step 416, and ends at step 418. This collection of steps may be performed, for example, on a server, such as cloud privacy management server 104 or system 200, or cloud server 106.

In operation, process flow 400 starts at step 402. At step 404, the system may receive and register privacy settings that include one or more privacy groups with one or more privacy subcategories associated with each privacy group. In certain embodiments, registration may involve storing the privacy groups and privacy subcategories in a database so that those configurations can be consulted later to implement access control according to the present disclosure. For example, a privacy setting may include privacy group for family and privacy subcategories for the family privacy group may include immediate family and extended family subcategories. Network users may provide privacy settings for registering privacy group and privacy subcategories using any appropriate endpoint device, such as desktop computer 108, laptop computer 110, or mobile device 112.

Next, process flow 400 continues to the member population step 406. In this step, the system determines which members (e.g., network users) to populate and associate with the privacy groups and privacy subcategories. In particular embodiments, an appropriate database may store the membership for each privacy group and privacy subcategory. In certain embodiments, the members associated with each privacy group or privacy subcategory may be provided with a network user, such as the network user responsible for configuring the privacy groups and privacy subcategories. In other embodiments, the system may connect to appropriate servers or networks (e.g., social media servers/networks) to determine a relationship between the network user and a candidate member of a privacy group or privacy subcategory. For example, the system may detect from social media or other database that a particular network user is the sibling of the present network user, and as a result, add them to a family privacy group or immediate family privacy subcategory. In a similar manner, immediate and extended friends, coworkers, customers, employers, financial, medical, and other relationships may be detected and determined by the system by connecting to appropriate networks or databases. In certain embodiments, consulting the database may require communicating over a communication network to another server. For example, the system may consult an appropriate database to determine the relationships between network users. Other automatic detection techniques may also be employed without departing from the scope of the present disclosure, including for example, seeking relationship confirmation from other network users.

At step 408, the system may receive a file for sharing. In this step, the candidate file for sharing may be uploaded by the network user for sharing. In that embodiment, the system may store the file in a cloud server that is accessible to network users before determining the access control or privacy controls to apply to the file. In other embodiments, the network user may identify a file that may be already stored in a cloud server or is accessible across a private or public network to the cloud server.

Next, process flow 400 proceeds to the file characteristic decision step 410. In this step 410, the system may determine whether characteristics associated with the file can be assessed. Characteristics of a file may include file characteristics such as metadata, file contents, or file content analysis, or some combination thereof. In this step, the system determines whether it can assess the character of the file such that it can be associated with particular privacy groups or privacy subcategories in later steps. If the characteristics of the file can be assessed, process flow 400 proceeds to step 412. If the characteristics of the file cannot be assessed, process flow 400 ends at step 418. In particular embodiments, the file is a photograph, and identifying the characteristic of a file may involve detecting the network users in the photograph, such as immediate family members. In other embodiments, determining the file characteristics may include determining the author, entity from which the file originated, or collaborators, reviewers, or contributors associated with the file. For example, if a driver's license is shared, the system may detect as a file characteristic the fact that the driver's license issued from the department of motor vehicles for a particular state. As another example, if a word processing document edited by five collaborators is identified for sharing, the system may detect that that the file was edited by five collaborators who are immediate friends. In alternative embodiments, if the characteristics of the file cannot be detected, the network user may be prompted to identify appropriate file characteristics or inform the system of privacy group or privacy subcategories to associate with the file for access control.

If file characteristics were detected in step 410, process flow 400 proceeds to determine access control step 412. In step 412, the system determines the privacy group and/or privacy subcategory to associate with the file selected for sharing. In one embodiment, if the file that is shared is a family photograph, the system may detect the network users in the photograph and compare those network users against the registered privacy groups and privacy subcategories to determine that those network users are members of the family privacy group and more specifically the immediate family privacy subcategory. In certain embodiments, for example, if the file that is shared is detected to have five editors or collaborators, the system may compare those five collaborators against the registered privacy groups and privacy subcategories to determine that all those five collaborators are members of the friends privacy group, and more specifically the immediate friends privacy subcategory. Accordingly, in certain embodiments, the file characteristics may influence the access control to be applied to the file with reference to the registered privacy groups and privacy subcategories. Next, process flow 400 proceeds to privacy assignment step 414. In this step, the privacy ground and/or privacy subcategory are assigned to the file based on the determination that took place in step 412. For example, if a file contains a representation or information about immediate family members (e.g., a photograph), it may be assigned to the family privacy group, and the immediate family privacy subcategory. As another example, if the file is detected to have five collaborators that are members of immediate friends privacy subcategory, the system may assign the file to the friends privacy group and the immediate friends privacy subcategory.

Once process flow 400 reaches the file access step 416, the system may receive a subsequent request from a network user for access to a file on a cloud server. The system then may grant access to the file based on the privacy group and/or privacy subcategories associated with the file and the members that have been populated in the privacy group and/or privacy subcategory. For example, immediate family members may be granted access to a photograph in which they appear. In another example, a document that has five collaborators who are immediate friends may all be granted access to the document for further editing. In certain embodiments, granting access to a file may involve determining whether the file, privacy group, or privacy subcategory is associated with a timer or expiration date which restricts access to the file for a specific period of time. In implementations where the timer or expiration date is associated with the file, the file may no longer be accessed after the timer expires or after the expiration date. In other implementations where there are different times or expiration dates for different privacy groups or privacy subcategories, the system may grant differentiated access to the file such that members of certain privacy groups or privacy subcategories have access to the file for varying periods of time. In yet other embodiments, timers or expiration dates may be associated with both files and privacy groups or privacy subcategories. In other embodiments, accessing an expired version of a file may cause the system to provide the latest unexpired version of the file (e.g., a recently-renewed driver's license). Accordingly, in file access step 416, the system may access to files on the cloud server based on access control policies configured in part by the registered privacy groups and/or privacy subcategories of the system. Process flow 400 ends at step 418.

While flow chart 400 is illustrated as including specific steps arranged in a particular sequence, it should be understood that various embodiments may operate using any suitable arrangement and collection of steps capable of providing functionality such as that described. Accordingly, modifications, additions, or omissions may be made to flow chart 400 as appropriate.

Although the present disclosure describes several embodiments, it should be understood that a myriad of changes, substitutions, and alterations can be made without departing from the spirit and scope of the invention as defined by the appended claims.

What is claimed is:

1. An apparatus, comprising:
a user interface operable to receive a request to share a file on a cloud server over a network, and one or more privacy settings, wherein the privacy settings comprise a privacy group and at least one privacy subcategory for the privacy group;
a memory operable to store the request and the privacy settings;
a network interface operable to communicate with the network;
a processor communicatively coupled to the user interface, the memory, and the network interface, the processor operable to:
receive the privacy settings;
register the privacy group according to privacy settings;
receive the request to share the file over the network from a first user;
determine, based on a characteristic of the file, the privacy subcategory of the registered privacy group to associate with the file;
assign the associated privacy subcategory to the file;
grant, in response to a subsequent request for the file, access to the file based on the assigned privacy subcategory.

2. The apparatus of claim 1, wherein the processor is further operable to populate the privacy subcategory of the privacy group with a member, wherein the member identifies a second user with access to files assigned to the privacy subcategory.

3. The apparatus of claim 2, wherein populating the privacy subcategory comprises the first user assigning the member to the privacy subcategory.

4. The apparatus of claim 2, wherein populating the privacy subcategory comprises automatically assigning the member to the privacy subcategory based on a detected relationship between the first user and the second user.

5. The apparatus of claim 1, wherein the characteristic of the file for determining the privacy subcategory of the registered privacy group to associate with the file comprises metadata associated with the file.

6. The apparatus of claim 1, wherein the characteristic of the file for determining the privacy subcategory of the registered privacy group to associate with the file comprises contents of the file.

7. The apparatus of claim 1, wherein granting access to the file based on the assigned privacy subcategory further comprises determining whether a timer associated with the document has expired and granting access to the file only if the timer has not expired.

8. A method, comprising:
receiving privacy settings, wherein the privacy settings comprise a privacy group and at least one privacy subcategory for the privacy group;
registering, in a memory, the privacy group according to privacy settings;
receiving a request to share the file over a network from a first user;
determining, using a processor, the privacy subcategory of the registered privacy group to associate with the file based on a characteristic of the file;
assigning the associated privacy subcategory to the file;
granting, in response to a subsequent request for the file, access to the file based on the assigned privacy subcategory.

9. The method of claim 8, further comprising populating the privacy subcategory of the privacy group with a member, wherein the member identifies a second user with access to files assigned to the privacy subcategory.

10. The method of claim 9, wherein populating the privacy subcategory comprises the first user assigning the member to the privacy subcategory.

11. The method of claim 9, wherein populating the privacy subcategory comprises automatically assigning the member to the privacy subcategory based on a detected relationship between the first user and the second user.

12. The method of claim 8, wherein the characteristic of the file for determining the privacy subcategory of the registered privacy group to associate with the file comprises metadata associated with the file.

13. The method of claim 8, wherein the characteristic of the file for determining the privacy subcategory of the registered privacy group to associate with the file comprises contents of the file.

14. The method of claim 8, wherein granting access to the file based on the assigned privacy subcategory further comprises determining whether a timer associated with the document has expired and granting access to the file only if the timer has not expired.

15. An system, comprising:
a client device associated with a user and coupled to a network, the client device operable to request to share a file on a cloud server over a network and provide one or more privacy settings, wherein the privacy settings comprise a privacy group and at least one privacy subcategory for the privacy group;
a data server comprising a memory and a processor, the processor operable to:
receive the privacy settings;
register the privacy group according to privacy settings;
receive the request to share the file over the network from a first user on the client device;
determine, based on a characteristic of the file, the privacy subcategory of the registered privacy group to associate with the file;
assign the associated privacy subcategory to the file;
grant, in response to a subsequent request for the file, access to the file based on the assigned privacy subcategory.

16. The system of claim 15, wherein the processor is further operable to populate the privacy subcategory of the privacy group with a member, wherein the member identifies a second user with access to files assigned to the privacy subcategory.

17. The system of claim 16, wherein populating the privacy subcategory comprises automatically assigning the member to the privacy subcategory based on a detected relationship between the first user and the second user.

18. The system of claim 15, wherein the characteristic of the file for determining the privacy subcategory of the registered privacy group to associate with the file comprises metadata associated with the file.

19. The system of claim 15, wherein the characteristic of the file for determining the privacy subcategory of the registered privacy group to associate with the file comprises contents of the file.

20. The system of claim 15, wherein granting access to the file based on the assigned privacy subcategory further comprises determining whether a timer associated with the document has expired and granting access to the file only if the timer has not expired.
